(19) United States
(12) Patent Application Publication
(10) Pub. No.: US 2005/0087350 A1
(43) Pub. Date: Apr. 28, 2005

(54) Sectional toolbar for a planter

(76) Inventor: Vaughn L. Bauer, Paton, IA (US)

Correspondence Address: STURM & FIX LLP, 206 SIXTH AVENUE, SUITE 1213, DES MOINES, IA, 50309-4076, US

(21) Appl. No.: 10/695,011

(22) Filed: Oct. 28, 2003

(51) Int. Cl. A01B 49/00

(52) U.S. Cl. 172/311

(57) ABSTRACT

Implement toolbars as used for planters have become very long in recent years. In order to assure good ground contact, the long toolbar of the present invention is divided up into more than three sections, including a center section and wing sections. The wing sections fold forward for transport on public roads, over field accesses, and through gates. The resulting planter can be longer than prior art planters while providing sound ground contact and a compact transport mode.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates generally to an agricultural device. More particularly the present invention relates to a planter toolbar comprising more than three sections, and is horizontally foldable.

2. Background Art

Fences are being removed in the corn belt. For this reason and because the acreage farmed by the typical farmer is increasing, field equipment, in particular planters, are being built to cover more and more crop rows as the years go by. Roads, however, are not being significantly widened. Therefore, schemes for folding or rotating wide equipment have been devised for the purpose of transporting this large machinery on public roads.

An additional consideration is that farm ground is not perfectly flat. So a planter of significant width cannot be assembled on a rigid toolbar lest some of the row units be off the ground at times, and therefore, ineffective. Present-day planter toolbars have three sections for flexibility over uneven terrain. Difficulties arise in attempting to extend this to more than three sections.

Friesen et al., in U.S. Pat. No. 5,113,956, disclose a forwardly folding, three section toolbar. A center section is held at a right angle to the tongue, while wing sections pivot on the ends of the center section. When in a field position, the wing sections are pivoted to be substantially collinear with center section. When in transport mode, the wings are pivoted to be substantially parallel to the tongue, and on either side, thereof.

A five-section implement toolbar is disclosed by Smith in U.S. Pat. No. 6,089,329. The toolbar disclosed folds upwardly (vertically) when in transport mode, exhibiting a high ground clearance and the stresses resulting from carrying the weight of the wings on a pivot.

There is therefore a need for an implement toolbar having five or more sections that can be folded horizontally—forwardly or backwardly—for transport.

### BRIEF SUMMARY OF THE INVENTION

An advantage of the present invention is the use of a five-section toolbar. Because farm fields are not perfectly planar, to ensure the planter units contact the soil, flexibility must be built into a planter toolbar. Ideally, each unit would “float,” such that it could be in contact with the soil, irrespective of the soil level for any other unit. A toolbar with only two units per section could provide this ideal flexibility, but at a high cost of complexity, maintenance, and reliability. A compromise is to divide the toolbar into as many sections as practical. For the present invention, that number of sections is more than three and, typically, five.

An additional advantage of the present invention is the horizontal (that is, within a substantially horizontal plane) folding of a five or more section toolbar for transport on public roads and through narrow gateways. The present invention uses a telescoping tongue similar or identical to the three-section toolbars, but has overcome the difficulty of the additional pivot points. When in transport mode, the wing sections are borne by the tongue. The tongue, in turn, is supported at its forward end by the tractor draw bar, and its rearward end by wheels situated near the rear end of the tongue. At the extreme ends of the toolbar, as well as at each sectional pivot point, a latch is provided for transferring the weight of the wing sections to the tongue. Wheels at each pivot point and at the extreme ends of the wings carry the weight of the wing sections when the implement toolbar is extended in its field position. Actuators between the wheels and the toolbar raise the toolbar relative to the wheels for folding. Once the wings have arrived in their forward positions, the wing sections are lowered so the latches carry their weight on the tongue and the wheels are raised off the surface.

Between each of the toolbar sections is a pivot point allowing the sections to be noncollinear with one another for the purpose of following the ground contour.

Other objects, advantages and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a perspective view of a planter;

FIG. 2 is a perspective view of a five-section toolbar;

FIG. 3 is a perspective view from the back of a latch for stabilizing a toolbar wing to a toolbar tongue;

FIG. 4 is a perspective view from the front of a latch for stabilizing a toolbar wing to a toolbar tongue;

FIG. 5 is a perspective view of a toolbar in a process of folding;

FIG. 6 is a perspective view of a toolbar in a folded configuration;

FIG. 7 is a perspective view, substantially from the front, of a five-section toolbar showing its flexibility;

FIG. 8 is a perspective view, substantially from the back, of a five-section toolbar showing its flexibility;

FIG. 9 is a perspective view, substantially from the front, of a planter assembled on a five-section toolbar showing its flexibility;

FIG. 10 is a perspective view, substantially from the back, of a five-section toolbar assembled on a showing its flexibility;

FIG. 11 is a perspective view of the latches and the tongue of the five-section toolbar; and

FIG. 12 is a perspective view, substantially from the rear of the five-section toolbar in the folded and latched configuration.

### DETAILED DESCRIPTION OF THE INVENTION

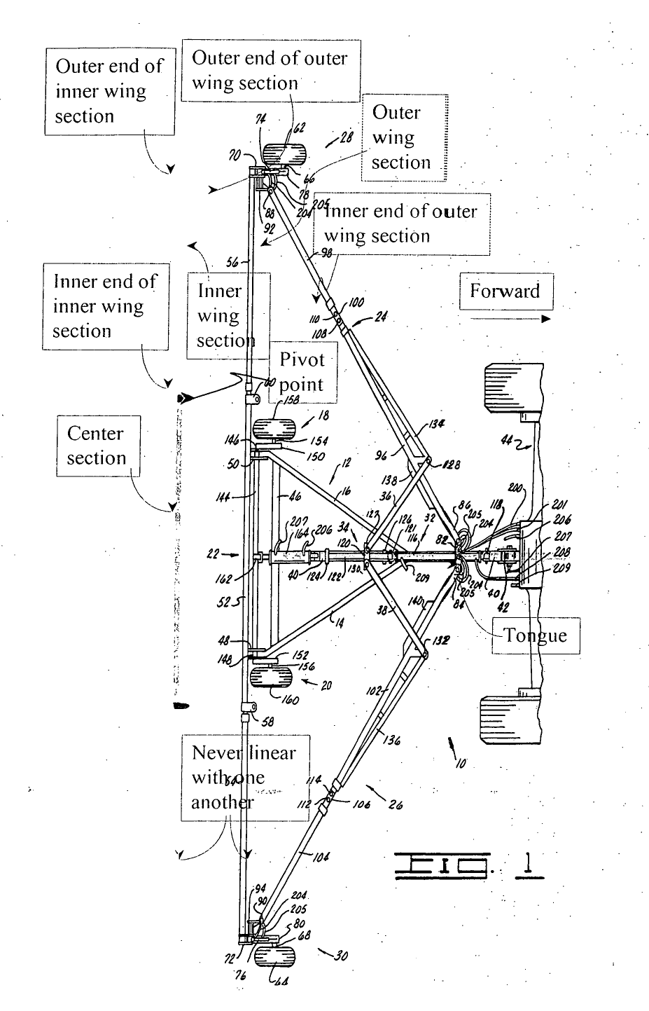

A complete planter 100 is shown in FIG. 1. The planter 100 is drawn by a tractor or other vehicle by its tongue 110, which is telescopic and an integral part of the foldability of the planter for road transport, gate access, and storage.

A center wheel assembly 120 carries the weight of the tongue 110 and the center portion of the planter 100. During transport, the center wheel assembly 120 carries all the weight carried by wheels on the planter.

Center wing wheel assemblies 130 support weight in between the tongue 110 of the planter 100 and the ends of the planter 100.

End wing wheel assemblies 140 bear the weight of the ends of the planter 100.

Planter units 150, with containers carrying seed, and the components for opening the ground, dropping the seed, and compacting the soil around the seeds are shown lined up across the planter 100.

Markers 160 provide a gage line for aligning the tractor and planter for each trip across the field.

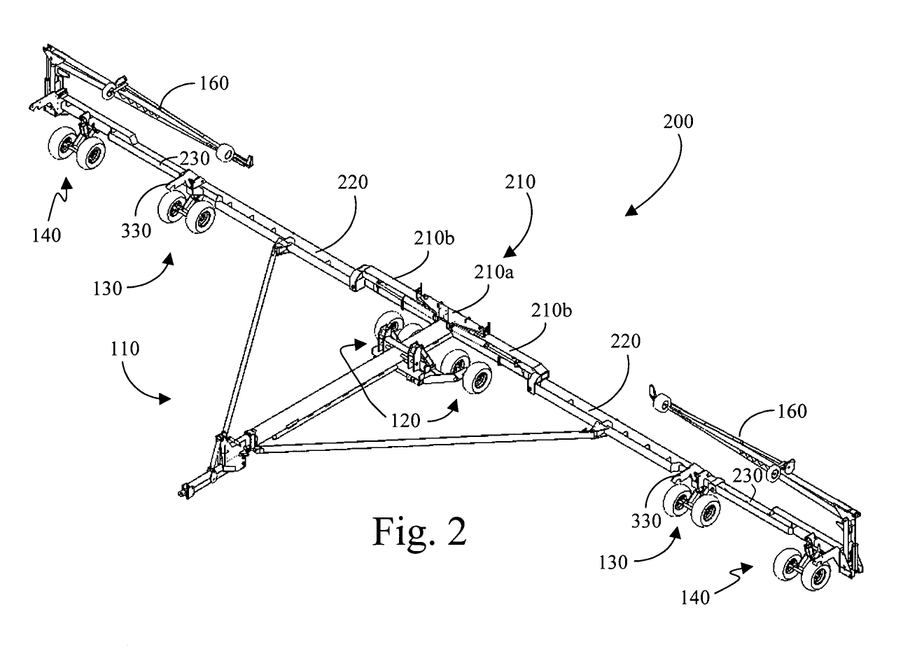

The planter units 150 are removed in FIG. 2 to clearly show the five section toolbar 200.

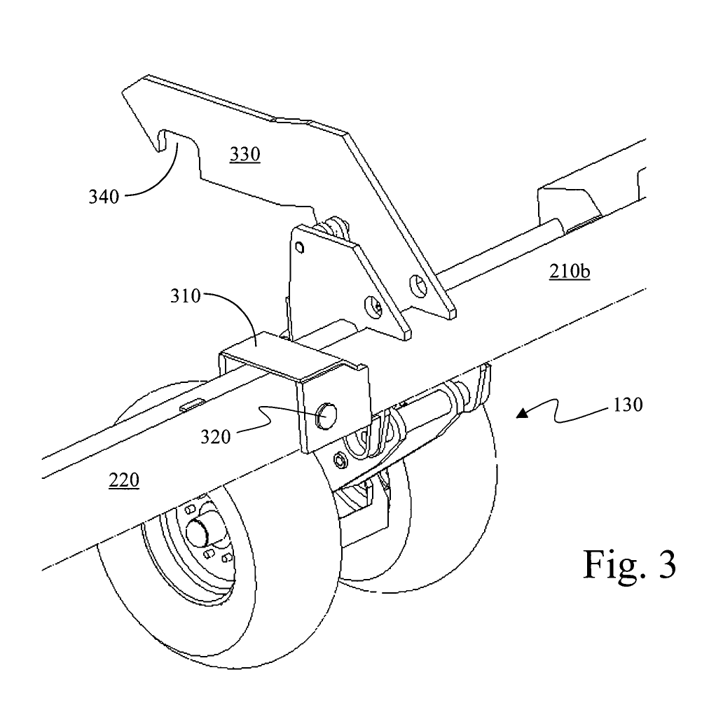

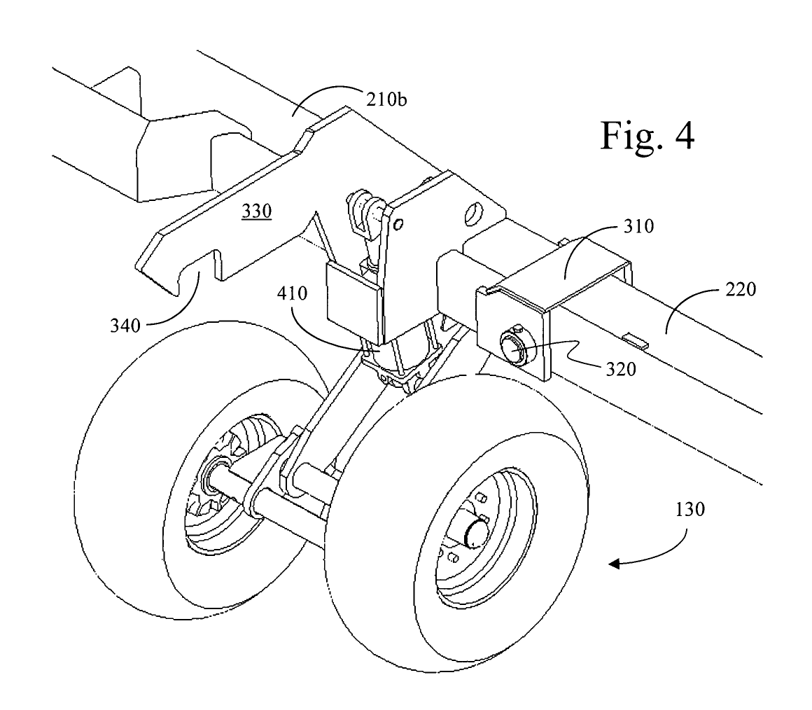

A center section 210 is made up of three subsections. A center subsection 210a remains substantially stationary relative to the tongue 110. The two outer subsections 210b pivot for folding, as will be explained, later. At each end of the center section 210 is a hinge assembly 310 (FIGS. 3 and 4 show a hinge assembly for another part of the toolbar 200, but the present hinge assembly is the same as shown) to which an inner wing section 220 is pivotally attached. When the planter 100 is in its field position, a hinge pin 320 lies substantially parallel to a direction of travel so the center section 210 and the inner wing sections 220 remain substantially in a substantially vertical plane throughout the allowed travel of the inner wing section 220 relative to the center section 210.

Two outer wing sections 230, one mounted on each end of the inner wing sections 220 by hinge assemblies 310, provide additional length to the toolbar, while also providing necessary flexibility. The hinge pin 320 again lies substantially parallel to the direction of travel, and permits the outer wing sections 230 to flex relative to the inner wing sections 220 within a substantially vertical plane.

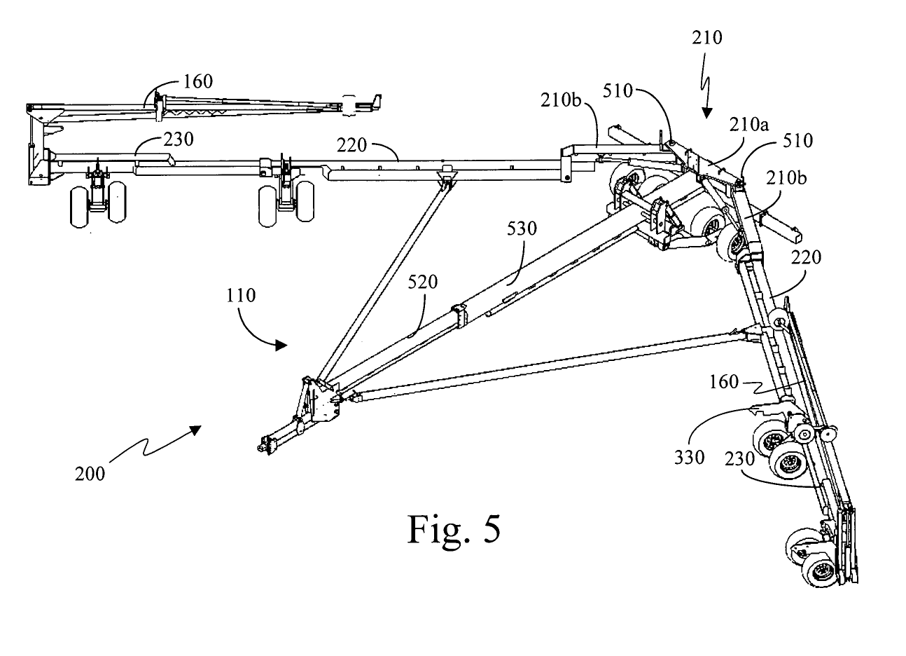

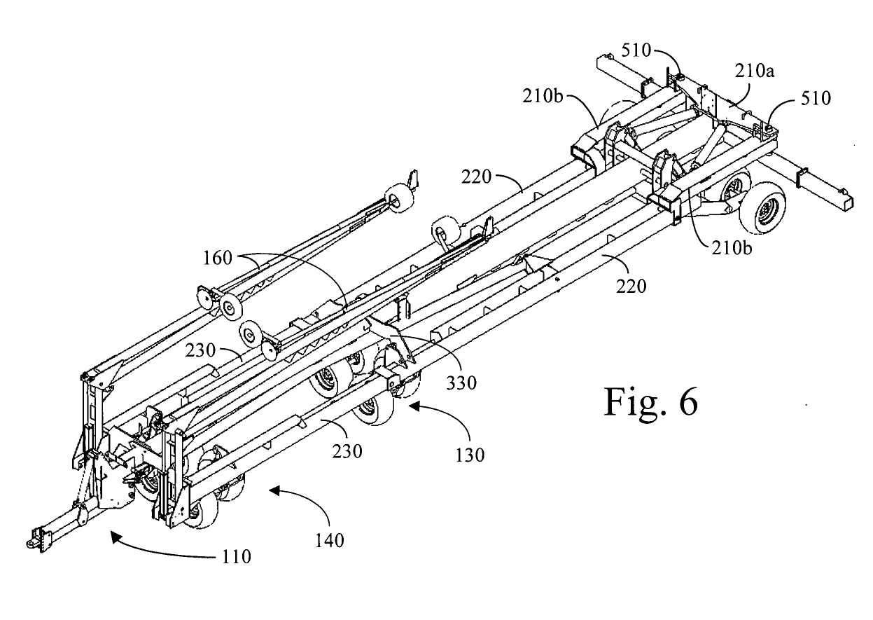

The process for transport and storage is begun as shown in FIG. 5. During the folding process, the tongue assembly 110 telescopes. The inner tongue portion 520 slides forward and out of the outer tongue portion 530. The telescoping of the tongue assembly 110 causes the wing sections 220, 230 at each end of the center section 210, as well as the two outer center subsections 210b to rotate in a substantially horizontal plane about pivot points 510 in the center section 210 until they are approximately parallel to the tongue assembly 110 as shown in FIG. 6. The inner wing section 220, the outer wing section 230, and the outer center subsection 210b at each end remain substantially in a substantially vertical plane during the process. A latch assembly 330 is used to stabilize the wing sections 220, 230 with the tongue 110 upon completion of the folding which is illustrated in FIG. 6 where the toolbar 200 is completely folded and latched. A notch 340 in the latch assembly 330 engages the inner tongue portion 110 when latched. The latch assembly 330 thereby fits over the top of the inner tongue portion 520 in the latched position thereof.

The toolbar 200 of the present invention could also be foldable by rotating the wing sections 220, 230 backward instead of forward. Such a rear-folding embodiment is not disclosed herein, but is contemplated by the claims because such alternate embodiment could easily be accomplished by a reversal of parts where needed.

During the folding process of the embodiment shown in the drawings, wheel hydraulic cylinders 410 (FIG. 4) at the wing wheel assemblies 130, 140 raise the wing sections 220, 230 relative to the wing wheel assemblies 130, 140. Once the wings 220, 230 have rotated completely from the FIG. 5 position to the FIG. 6 position, the wheel hydraulic cylinders 410 lower the wing sections 220, 230 relative to the wing wheel assemblies 130, 140, thus engaging the latch assembly 330 to the tongue 110 wherein the notch 340 in the latch assembly 330 engages the inner tongue portion 520 by fitting over and down onto the inner tongue portion 520 which is directly behind the hitch.

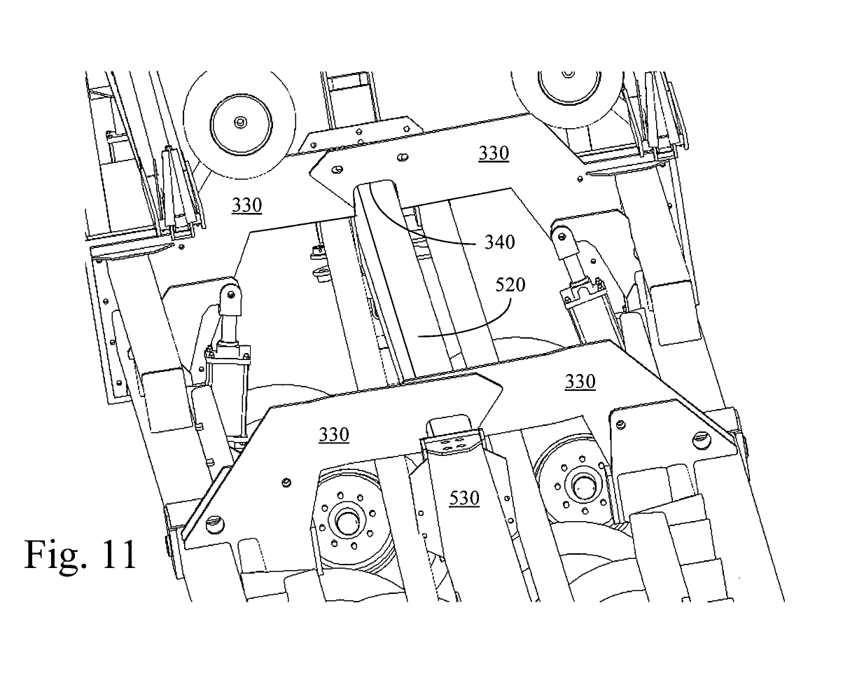

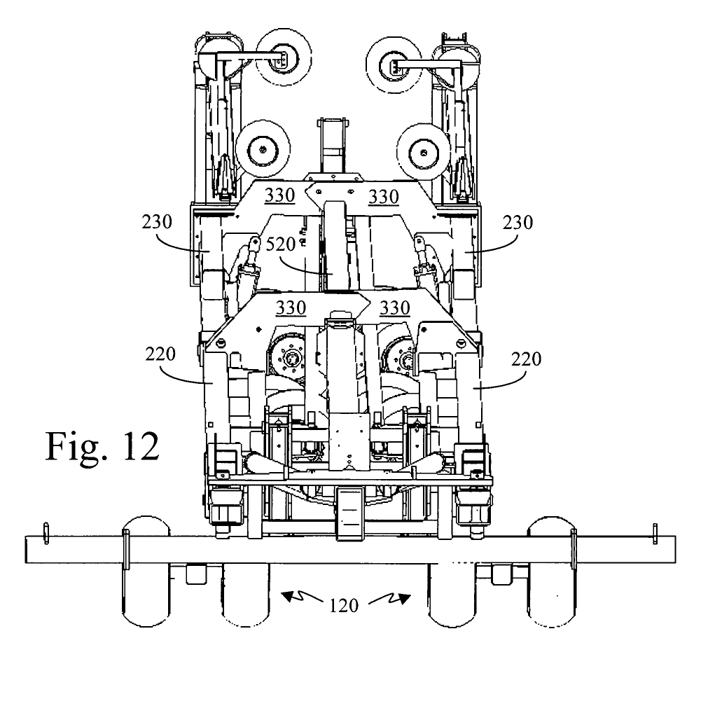

Views of the five-section toolbar 200 in its folded configuration are shown in FIGS. 11 and 12. In particular, the latch assemblies 330 are shown with the toolbar tongue 110 engaged in their notches 340. The toolbar 200 is completely folded and the wings 220, 230 stabilized to the tongue 110 for transport or storage.

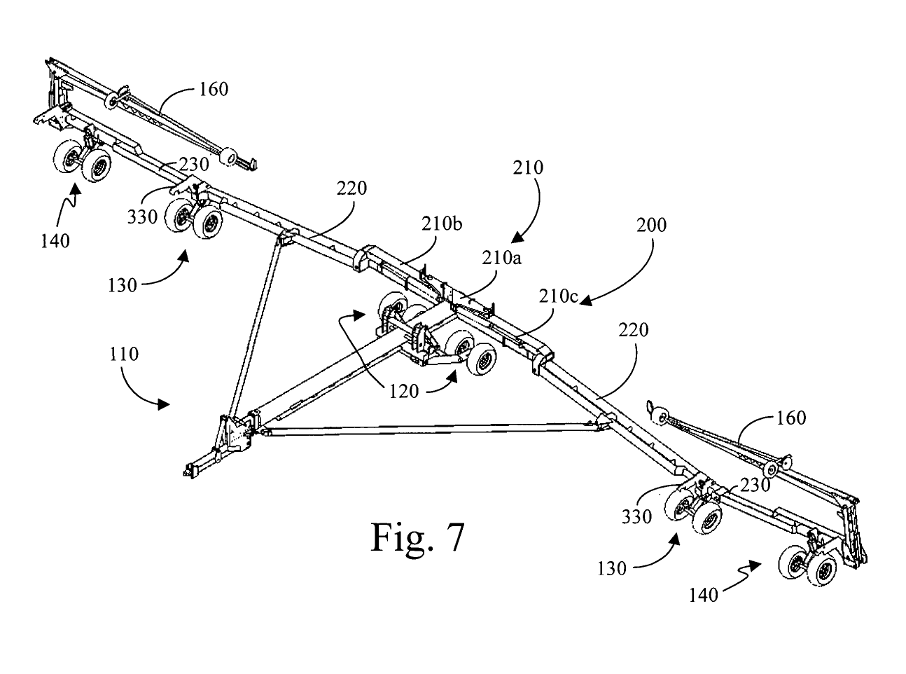

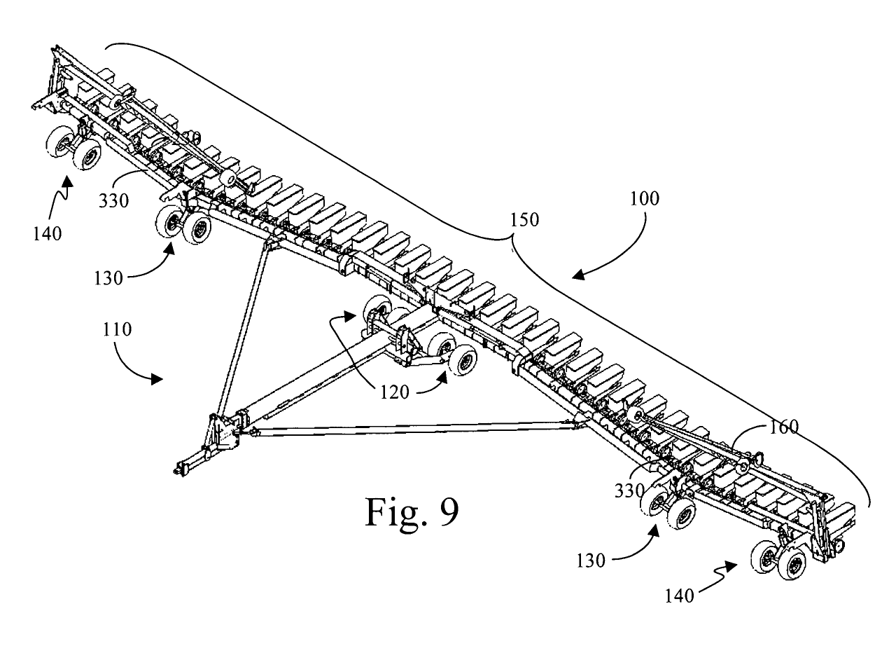

A main advantage of the five-section toolbar 200 is shown in FIGS. 7-10. Because fields are not, in general, planar, a planter and other field equipment must flex to follow the existing ground contours. The toolbar 200 is shown in a flexed shape from in front and above in FIG. 7 and in FIG. 9 it is shown flexed and with the planter units 150 attached to emphasize that the implement must contact the soil surface.

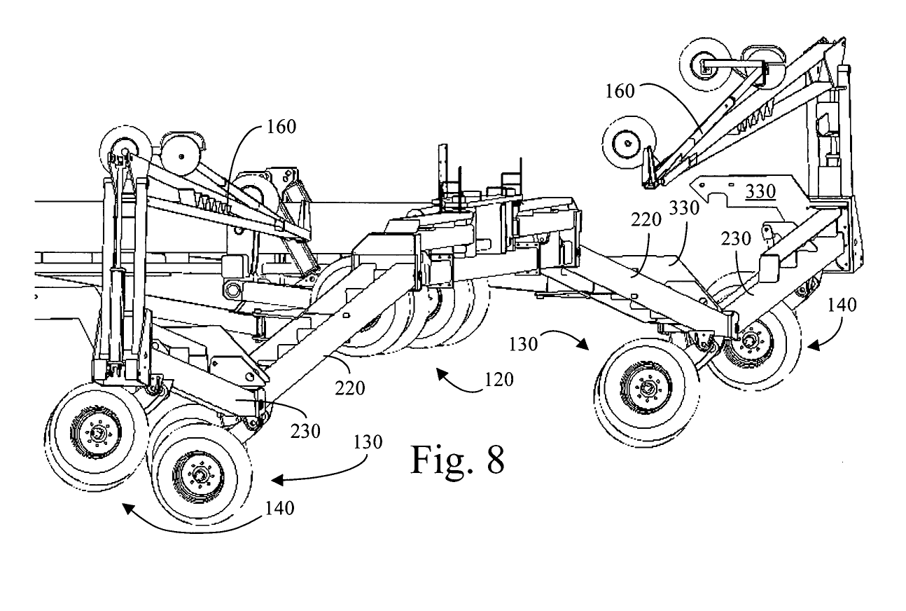

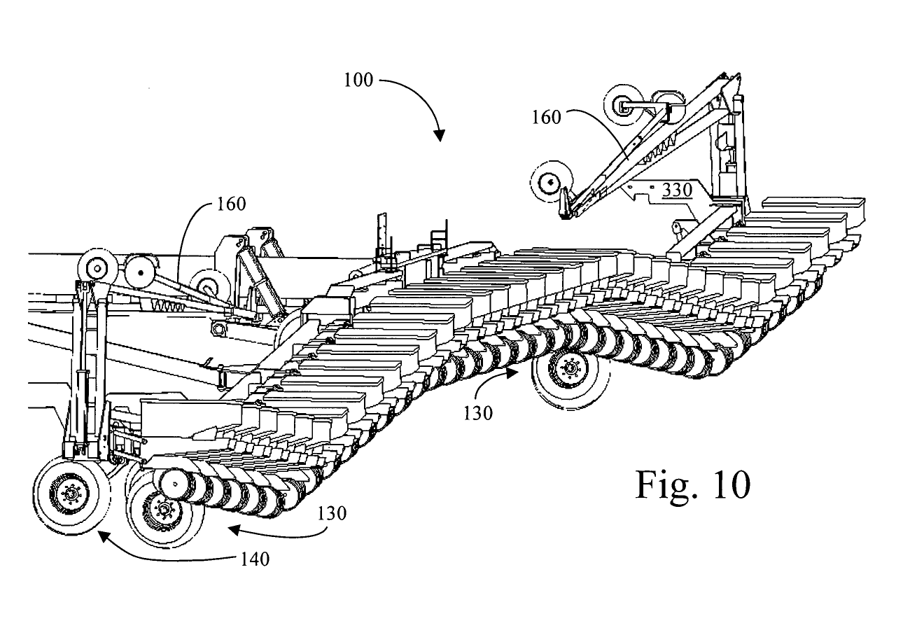

The toolbar 200 is shown from a rear corner in FIGS. 8 and 10. Again, the toolbar 200 is flexed to indicate an advantage of the five-section design over the prior art. With planter units 150 attached, the need for flexing is obvious: so the units are in contact with the ground.

The above embodiment is the preferred embodiment, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A method of providing a forwardly folding toolbar for a farm implement, said toolbar being operably connected to a tongue, the method comprising:
(a) operably attaching a center section to the tongue of the toolbar at a substantially right angle;
(b) operably pivotally attaching an inner end of an inner wing section to each end of the center section;
(c) operably pivotally attaching an inner end of an outer wing section to an outer end of each inner wing section; and
(d) rotating both wing sections at pivot points located on the center section to bring outer ends of the wing sections forward until the wing sections lie substantially parallel to the tongue.

2. The method of claim 1 additionally comprising supporting the center section with ground engaging wheels.

3. The method of claim 1 additionally comprising supporting pivot points between each of the wing sections with ground engaging wheels.

4. The method of claim 1 additionally comprising supporting ends of the outer sections with ground engaging wheels at each extreme end of the outer wing sections.

5. The method of claim 3 wherein actuators are provided for raising the pivot points relative to the ground engaging wheels, upon folding, the method additionally comprising raising the pivot points between each of the wing sections relative to the ground engaging wheels with the actuators therebetween before the step of rotating both wing sections.

6. The method of claim 4 wherein actuators are provided for raising the pivot points relative to the ground engaging wheels, upon folding, the method additionally comprising raising the extreme end of each of the wing sections relative to the ground engaging wheels with the actuators therebetween before the step of rotating both wing sections.

7. The method of claim 5 additionally comprising the step of lowering the pivot points between each of the wing sections relative to the ground engaging wheels with the actuators therebetween when the wing sections lie substantially parallel to the tongue.

8. The method of claim 6 additionally comprising the step of lowering the extreme end of each of the wing sections relative to the ground engaging wheels with the actuators therebetween when the wing sections lie substantially parallel to the tongue.

9. The method of claim 7 additionally comprising engaging a latch to the tongue of the toolbar upon lowering the pivot points between each of the wing sections.

10. The method of claim 8 additionally comprising engaging a latch to the tongue of the toolbar upon lowering the extreme end of the wing section.

11. An implement toolbar that is forwardly folding comprising:
(a) a tongue having a forward end and a rearward end;
(b) a center section operably attached to the tongue at a substantially right angle;
(c) inner wing sections, operably pivotally attached at inner ends of the inner wing sections to each end of the center section;
(d) outer wing sections, operably pivotally attached at inner ends of the outer wing sections to an outer end of each inner wing section; and
(e) folding means for rotating both wing sections at pivot points located on the center section to bring outer ends of the wing sections toward the forward end of the tongue until the wing sections lie substantially parallel to the tongue.

12. The implement toolbar of claim 11 additionally comprising ground engaging wheels for supporting the center section.

13. The implement toolbar of claim 11 additionally comprising ground engaging wheels for supporting pivot points between each of the wing sections.

14. The implement toolbar of claim 11 additionally comprising ground engaging wheels for supporting ends of the outer sections, said ground engaging wheels being located substantially at each extreme end of the outer wing sections.

15. The implement toolbar of claim 13 additionally comprising actuators for raising the pivot points relative to the ground engaging wheels during folding.

16. The implement toolbar of claim 14 additionally comprising actuators for raising the pivot points relative to the ground engaging wheels during folding.

17. The implement toolbar of claim 15 additionally comprising latch for operably affixing a pivot point between the inner wing section and the outer wing section to the tongue of the toolbar by lowering the pivot point between each of the wing sections after the wing sections lie substantially parallel to the tongue.

18. The implement toolbar of claim 16 additionally comprising latch for operably affixing an extreme end of the outer wing section to the tongue of the toolbar by lowering the extreme end of the outer wing section after the wing sections lie substantially parallel to the tongue.

19. An implement toolbar that is horizontally folding comprising:
(a) a tongue;
(b) more than three sections comprising a center section having two ends and at least three wing sections, each operably pivotally attached end to end, all the sections lying substantially linearly from each end of the center section to an outer end of the wing sections; and
(c) folding means for rotating the at least three wing sections at pivot points located on the center section to bring outer ends of the at least three wing sections forward until the at least three wing sections lie substantially parallel to the tongue and substantially linearly from each pivot point located on the center section to a forward end of the wing sections.

20. The implement toolbar of claim 19 wherein the toolbar is forwardly folding.

21. The implement of claim 19 including a forward end of the tongue, adapted to be attached to a rear end of a prime mover.

22. The implement of claim 19 including a hitch disposed on a forward end of the tongue, said hitch being adapted to be attached to a rear end of a prime mover.

23. The method of claim 1 including attaching a forward end of the tongue to a tractor for towing the implement forwardly.
